(19) United States
(12) Patent Application Publication
(10) Pub. No.: US 2022/0024142 A1
(43) Pub. Date: Jan. 27, 2022

(54) MACHINE AND SYSTEM CONFIGURED TO MANUFACTURE A MASK

(71) Applicant: GVN Group Corp., Pontiac, MI (US)

(72) Inventors: Ghassan Victor Nasrallah, Pontiac, MI (US); Jonathan Noble, Pontiac, MI (US)

(21) Appl. No.: 17/184,689

(22) Filed: Feb. 25, 2021

Related U.S. Application Data
(60) Provisional application No. 63/054,550, filed on Jul. 21, 2020.

(51) Int. Cl. B29C 65/08; B29C 65/00; B29C 65/70; B29C 65/78

(52) U.S. Cl. CPC B29C 65/08; B29C 66/0326; B29L 2031/4835; B29C 65/70; B29C 65/7861; B29C 66/81421

(57) ABSTRACT

A machine for manufacturing a mask includes a plurality of carriers mounted to a belt so as and having a plurality of molding cavity inserts. A feed station supplies material from a roll so as to form a sheet of material on to the carriers. A shell forming station is configured to press a molding core inserts into the molding cavity inserts so as to form a shape of the mask. A welding station generates a predetermined ultrasonic vibration at a predetermined frequency and a predetermined amplitude so as to weld the sheet of material. A cutting station cuts out the mask from the sheet of material. A mask grabbing apparatus is configured to grab the mask and position the mask for retrieval.

### CROSS-REFERENCE TO RELATED APPLICATION

This patent application claims priority to U.S. Provisional Application No. 63/054,550, filed on Jul. 21, 2020, the contents of which are hereby incorporated by reference.

### TECHNICAL FIELD

The disclosure relates a machine and system for manufacturing a mask.

### BACKGROUND

Face masks are useful for filtering particulates such as respiratory droplets. Such masks may include a shell that is layered with a filtering material such as melt blown or spun nonwoven polypropylene fabric. Currently such manufacturing processing machines include a molding core for forming a shell out of a material such as polyethylene terephthalate, welding the filtering material onto the shell and then adding features to the mask.

As described above, the current manufacturing process is a 3-part process which involves forming the shell, wherein laborers lay the material over a molding core. The shells are then manually transferred to a welding unit which welds the melt blown nonwoven material onto the shell. Laborers are used to lay the filter material onto the shell. The laborers are careful to remove wrinkles from the filter material to ensure that the masks are completed with a smooth surface. The mask is then physically transferred to another unit which provides ancillary features such as straps, nose bridges and the like. Such current processes are time consuming and require manual labor, thus the number of masks produced is limited by the number of laborers available.

Accordingly, it remains desirable to have an automated machine, system and method which would form the body of the mask in an inline singular process without manual input.

### SUMMARY

Disclosed herein is a machine configured to manufacture a mask. The mask is formed of at least one material. The material is supplied by a roll of the material. The machine includes a controller, a frame and a conveyor. The controller is a programmable logic controller configured to control the various parts of the machine. The frame includes a gantry and a support plate disposed beneath the gantry. The support plate is fixed to the frame. The conveyor is operable to rotate belt. A plurality of carriers are fixedly mounted to the belt so as to be carried around the support plate. The carriers include a plurality of molding cavity inserts.

The machine further includes a feed station for supplying the material from the roll to the conveyor. The feed station includes a gripper and a guillotine. The gripper is configured to pull the material across the carrier. The guillotine is configured to cut the material from the roll so as to form a sheet of material on the carrier.

The machine further includes a shell forming station mounted to the gantry. The shell forming station includes a shell support and a plurality of molding core inserts disposed on the shell support. The shell forming station is configured to press the molding core inserts into the molding cavity inserts so as to press the material therebetween and form a shape of the mask.

The machine further includes a welding station. The welding station includes a welding base and a plurality of welding horns disposed on the welding base. The welding horns are configured to generate a predetermined ultrasonic vibration at a predetermined frequency and a predetermined amplitude so as to weld the sheet of material.

The machine further includes a cutting station. The cutting station includes a cutting base and a plurality of cutting dies disposed on the cutting base. The cutting dies are configured to cut out a peripheral of the mask from the sheet of material so as to separate the formed mask from the sheet of material.

The machine further includes a mask grabbing apparatus. The mask grabbing apparatus is configured to grab the masks from the molding cavities. The grabbing apparatus is rotatable about an axis between a first position and a second position. The mask grabbing apparatus includes a plurality of mask gripping cores. In the second position the mask gripping cores are seated with the molding cavity inserts. A pneumatic intake is coupled to each of the mask gripping cores. The pneumatic intake sucking the mask within each of the plurality of molding cavity inserts so as to retain the masks to the mask gripping cores. The mask grabbing apparatus is then movable to the first position wherein the mask on each of the mask gripping cores may be retrieved.

In one aspect, the machine further includes a rake assembly. The rake assembly includes a plurality of rakes spaced apart from each other. The rake assembly is spaced apart from the conveyor so as to engage a top surface of the carriers and remove a remaining portion of the sheet of material from the respective one of the plurality of carriers.

In one aspect, each of the carriers include a plurality of slits spaced apart from each other and disposed on the top surface of the plurality of carriers. The slits are configured to receive the rakes.

In another aspect, each of the slits has an arcuate bottom surface which is radial to a travel of a corresponding one of the carriers about a turn in the conveyor.

In another aspect, the gripper includes a pair of opposable fingers. The opposable fingers are configured to open and close. The gripper is movable along a first axial guide. The first axial guide traverses the length of the carrier. The gripper is movable between near position and a far position. In the near position the gripper is moved toward the roll of material and the fingers are closed onto the material. The gripper is then moved to the far position so as to pull the material across the carrier, wherein the guillotine cuts the material so as to form a sheet of material.

In one aspect of the machine, the carriers include at least one indent and the shell forming unit includes at least one draw pin and a biasing member. The draw pin is slidably mounted to the shell base and the biasing member is configured to urge a head of the draw pin downwardly with respect to the shell base so as to extend beyond a distal end of the molding core inserts. The conveyor is configured to position the draw pins so as a corresponding indent.

In another aspect of the machine, the machine includes a collar. The collar is removably engage to a shaft of the draw pin. The collar is mounted to the shaft of the draw pin so as to establish a stroke length of the at least one draw pin.

In another aspect of the machine, the molding core inserts, cavity inserts and cutting die are removable attached to the respective carriers, the shell base and the cutting base.

In another aspect of the machine, the cutting station includes a dampening member disposed between the cutting base and the plurality of cutting dies.

In another aspect of the machine, the machine further includes a registration assembly fixed to the support plate. The registration assembly includes a registration plate having a registration pin movable from an engaged position and a disengaged position. Each of the carriers have a registration slot, wherein the registration pin is configured to be inserted into the registration slot when the registration pin is moved to the engaged position so as to position the plurality of carriers with respect to the frame.

In another aspect of the machine, the machine further includes a position sensor. The position sensor is configured to detect a position of the carriers and transmit the position to the controller. The controller is configured to stop the conveyor when the position sensor detects the carriers are in a proper position.

In another aspect of the machine, the controller is further configured to actuate the registration assembly so as to move the registration pin into the engaged position after the controller has stopped the conveyor.

In another aspect of the machine, the machine includes a heating plate. The heating plate is disposed beneath the support plate. The heating plate is movable between an engaged position and a disengaged position, wherein in the engaged position the heating plate is thermally coupled to a respective one of the plurality of carriers.

In another aspect of the machine, the machine further includes an anvil. The anvil has an opening for receiving a respective on of the plurality of molding cores.

### BRIEF DESCRIPTION OF THE DRAWINGS

The embodiment set forth in the drawings are illustrative and exemplary and are not intended to limit the subject matter defined herein. The following description of the illustrative embodiments can be understood when read in conjunction with the following drawings where like structure is indicated with like reference numerals and in which:

FIG. 1A is a perspective view of the machine according to the first embodiment described herein.

FIG. 1B is a perspective view of an illustrative example of a mask manufacture by the machine shown in FIG. 1A.

FIG. 2 is an isolated view of the frame shown in FIG. 1.

FIG. 3 is a perspective view of the machine showing the gripper in a far position.

FIG. 4 is a perspective view of the machine showing the gripper in a near position.

FIG. 5 is a perspective view showing the grippers open.

FIG. 6 is a perspective view showing the guillotine.

FIG. 7 is a perspective view showing the draw pins in an extended position.

FIG. 8 is view of FIG. 8 showing the draw pins engaged with a corresponding indent of the carrier.

FIG. 9 is view of FIG. 8 showing the shell support closed with the molding cavity inserts of the carrier.

FIG. 10 is a perspective view showing the gripping cores in a second position.

FIG. 11 is a perspective view showing the gripping cores in a first position.

FIG. 12A is a view of FIG. 11 showing the rake engaged with the carrier.

FIG. 12B is a cross-sectional view of FIG. 12A taken along a longitudinal length of a rake.

FIG. 13 is a close up view of the cutting die.

FIG. 14 is an isolated view of the dampening member.

FIG. 15 is a perspective view showing the shot pin in a disengaged position.

FIG. 16 is a view of FIG. 15 showing the shot pin in an engaged position.

FIG. 17 is a perspective view showing the position sensor.

FIG. 18 is perspective view showing the hot plate in a heating position.

FIG. 19 is a view of FIG. 18 showing the hot plate in a down position.

### DETAILED DESCRIPTION OF PREFERRED EMBODIMENTS

Example embodiments will now be described more fully with reference to the accompanying drawings. Example embodiments are provided so that this disclosure will be thorough, and will fully convey the scope of those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well known technologies are not described in detail.

For consistency and convenience, directional adjectives are employed throughout this detailed description corresponding to the illustrated embodiments. The term “axial” as used throughout this detailed description and in the claims refers to a direction extending a length of a part. Also, the term “lateral” as used throughout this detailed description and in the claims refers to a direction extending a width of a part. In other words, the lateral direction may extend between opposing sides of a part along an axis orthogonal to the axial length. Furthermore, the term “vertical,” “upwardly” or “downwardly” as used throughout this detailed description and in the claims refers to a direction generally perpendicular to a lateral and longitudinal direction of the part as shown in the referenced figure. The term “front” refers to the portion of the machine in which the roll of material is introduced and the term “back” refers to the portion of the machine in which the mask is finally formed and positioned for retrieval. It will be understood that each of these directional adjectives may be applied to individual components of a part.

Implementations described herein are directed towards a machine for manufacturing a mask from a roll of at least one layer of material. The material is supplied by a roll of the material. The machine includes a frame having a gantry and a support plate disposed beneath the gantry. A conveyor is operable to rotate belt. A plurality of carriers are fixedly mounted to the belt so as to be carried around the support plate. The carriers include a plurality of molding cavity inserts.

The machine further includes a feed station for supplying the material from the roll to the conveyor. The feed station includes a gripper and a guillotine. The gripper is configured to pull the material across the carrier. The guillotine is configured to cut the material from the roll so as to form a sheet of material on the carrier.

The machine further includes a shell forming station mounted to the gantry and a welding station. The shell forming station is configured to form the shape of the mask. The welding station includes a welding horns configured to generate a predetermined ultrasonic vibration at a predetermined frequency and a predetermined amplitude so as to weld the sheet of material. The machine further includes a cutting station configured to cut out a peripheral of the mask from the sheet of material so as to separate the formed mask from the sheet of material. The machine further includes a mask grabbing apparatus configured to grab the masks from the molding cavities and position the masks for retrieval.

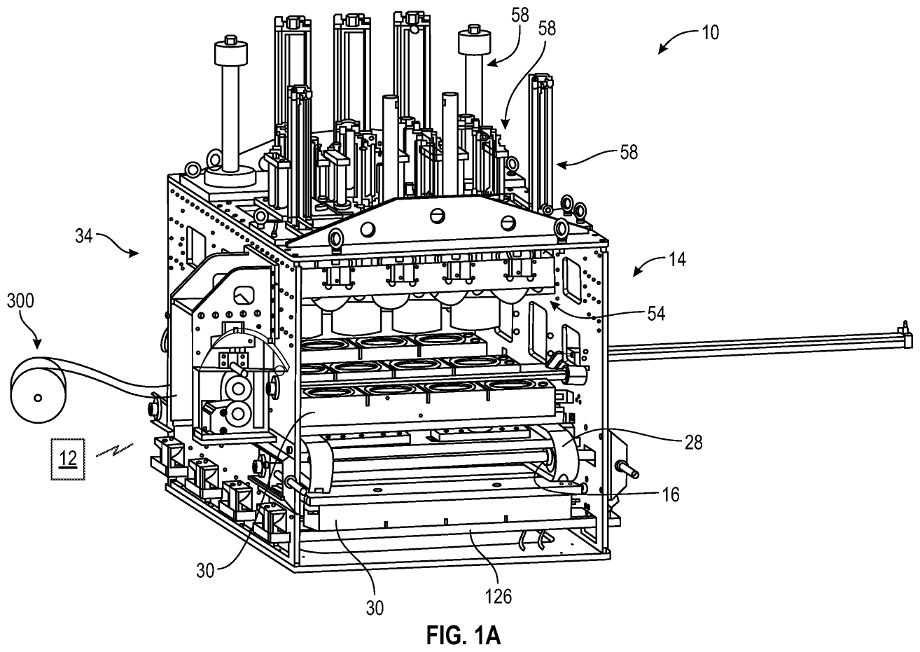

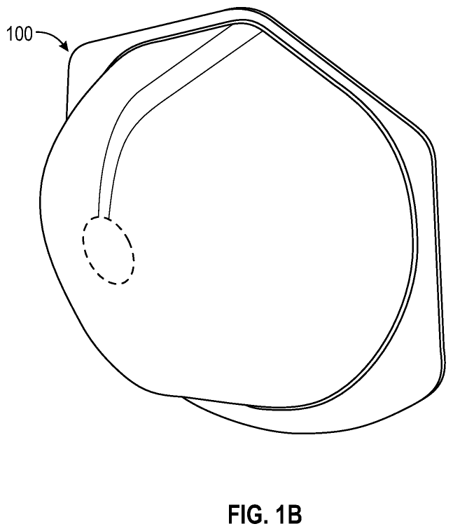

With reference now to FIG. 1A, the exemplary view of a machine 10 according to a first embodiment is provided. The machine 10 is configured to manufacture a mask 200, such as the mask 200 illustratively shown in FIG. 1B. The mask 200 is formed of at least one material. The material is supplied by a roll 300 of material. It should be appreciated that any material suitable for ultrasonic welding may be formed in the roll 300 and used herein and that the material may include one or more layers, and the layers may be made of different types of material. Any such material currently known and used or later developed may be used herein, illustratively including meltblown non-woven polypropylene fabric, spunbond non-woven polymer fabric and the like.

The machine 10 includes a controller 12, a frame 14 and a conveyor 16. The controller 12 is a programmable logic controller configured to control the various parts of the machine 10. The controller 12 may include a microprocessor, memory (e.g., volatile or non-volatile memory), a power supply (e.g., battery), input/output ports, or a combination thereof. The controller 12 is configured to control the operation of the machine 10 as will be described in greater detail below. The controller 12 may be integrated with the frame 14 or may be a standalone device in communication with the machine 10 via a wired or wireless connection.

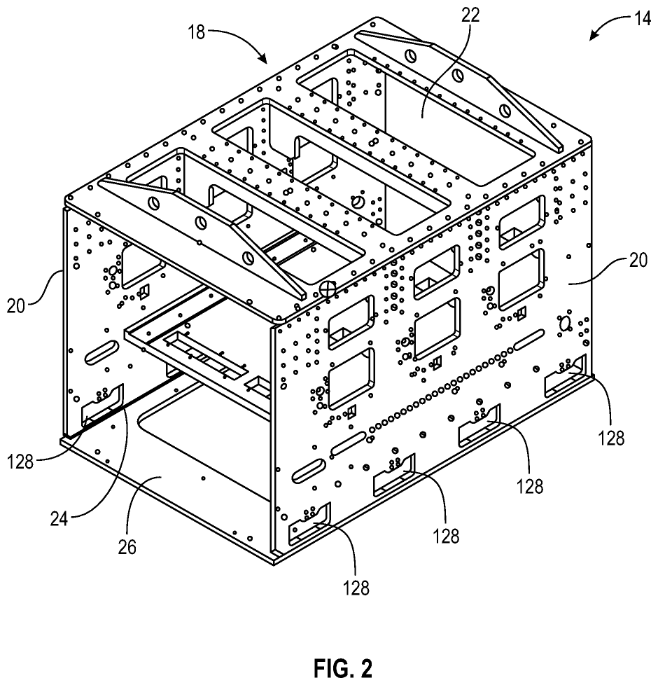

With reference again to FIG. 1A and also to FIG. 2, a description of the frame 14 is provided. The frame 14 is formed of a durable and rigid material, such as stainless steel and is configured to support the operation of the machine 10. The frame 14 is a cage like structure having an open front and an open back. The top, bottom and sides of the frame 14 are closed by generally planar panels.

The frame 14 includes a gantry 18 defined a top plate of the frame 14. The gantry 18 is fixedly mounted to the top of opposing side plates 20 of the frame 14. The gantry 18 has three elongated openings 22 for supporting components which are configured to execute mask forming functions.

The frame 14 includes a support plate 24. The support plate 24 is disposed beneath the gantry 18. The support plate 24 is fixed to the frame 14 and extends the width of the frame 14. The support plate 24 is suspended above a bottom plate 26 of the frame 14.

With reference again to FIG. 1A, the conveyor 16 is operable to rotate a belt 28. In particular, the conveyor 16 is driven by a motor mechanically coupled to the belt 28 so as to rotate the belt 28 in a continuous manner. The controller 12 is configured to actuate the conveyor 16 so as to index the belt 28 as is known in the art. In a preferred embodiment, the machine 10 includes at least two conveyors 16. The conveyors 16 may be diametrically opposed to each other either along the longitudinal axis of the frame 14 or across the width of the frame 14. Likewise, the machine 10 may include a pair of belts 28, each belt 28 is disposed on opposite sides of the frame 14.

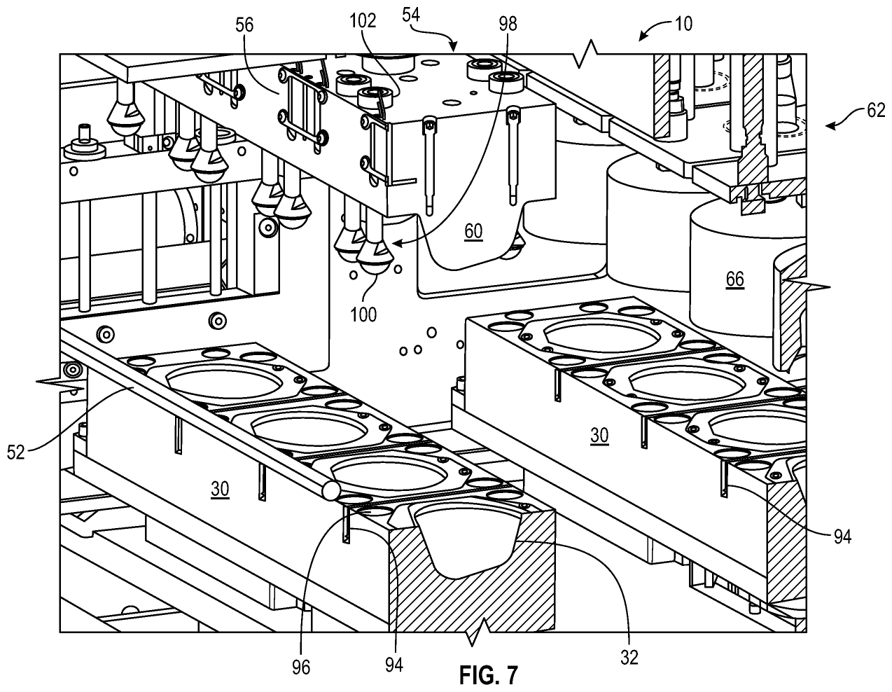

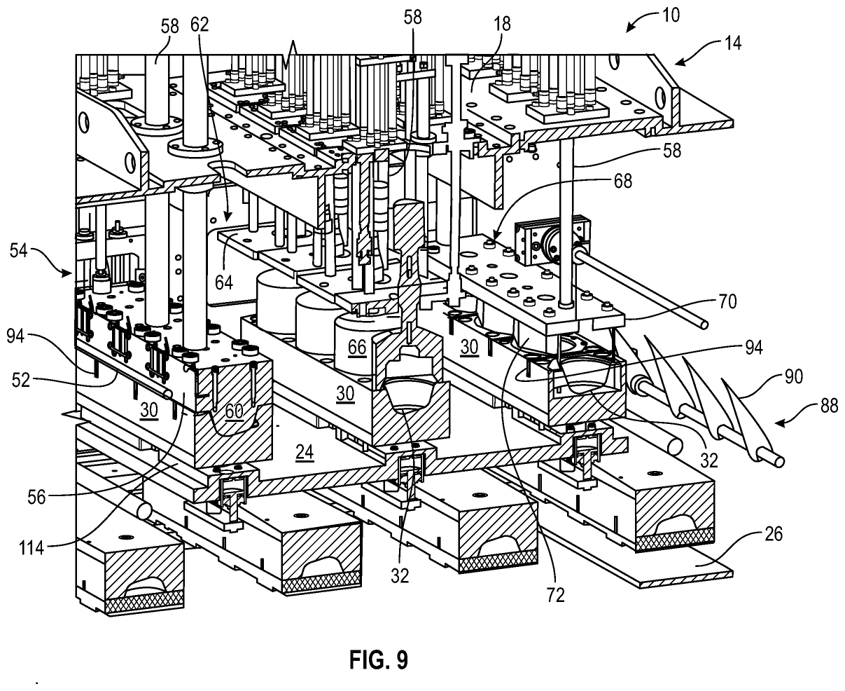

With reference again to FIG. 1 and now to FIGS. 7 and 9, the machine 10 includes a plurality of carriers 30 are fixedly mounted to the belt 28 so as to be carried around the support plate 24. In one aspect, the carriers 30 are a generally elongated cuboidal member extending along an axis measured by the width of the frame 14. For illustrative purposes, the machine 10s is shown as seven (7) carriers 30. However, it should be appreciated that the number of carriers 30 shown is not limiting to the scope of the appended claims. The carriers 30 include a plurality of molding cavity inserts 32. The molding cavity inserts 32 are dimensioned so as to form the outer surface of the mask 200. In a preferred aspect, the molding cavity inserts 32 are removably coupled to the carriers 30. For illustrative purposes, the carriers 30 are shown as having four molding cavity inserts 32, but it should be appreciated that the number of molding cavity inserts 32 are non-limiting.

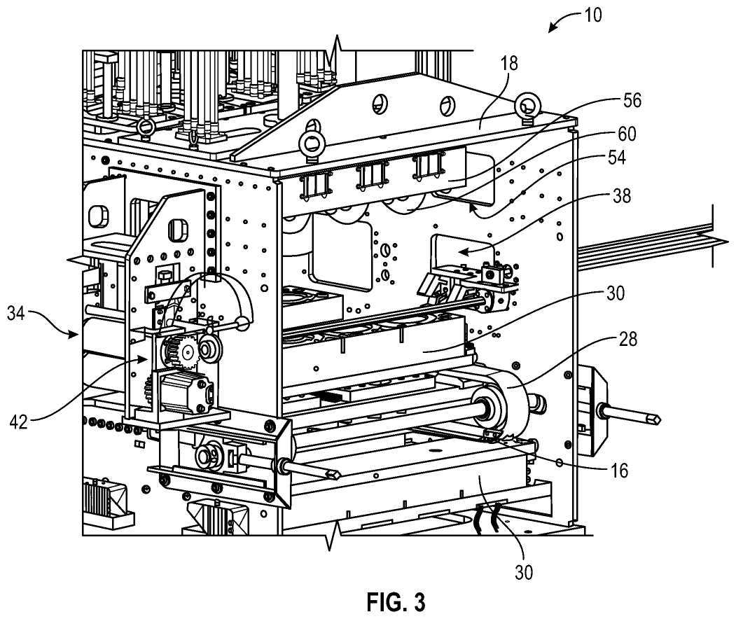

With reference again to FIG. 1 and now to FIGS. 3-6, the machine 10 further includes a feed station 34 for supplying the material from the roll 300 to the conveyor 16. The feed station 34 a feed 36 configured to hold the roll 300. The feed 36 is disposed on an outer surface of the frame 14. The feed 36 is configured to hold the roll 300 so as to allow the material to be pulled.

FIG. 3 illustrates step in the operation of the feed station 34. The feed station 34 further includes a gripper 38 and a guillotine 40. FIG. 3 shows the gripper 38 being disposed opposite of the feed 36. The feed 36 may have a tensioning element 42 configured to provide a predetermined tension on the roll 300.

The gripper 38 is configured to pull the material across the carrier 30. In particular, the gripper 38 is configured to grab the free end of the material from the roll 300 and pull the material across the carrier 30. The guillotine 40 is configured to cut the material from the roll 300 so as to form a sheet of material on the carrier 30.

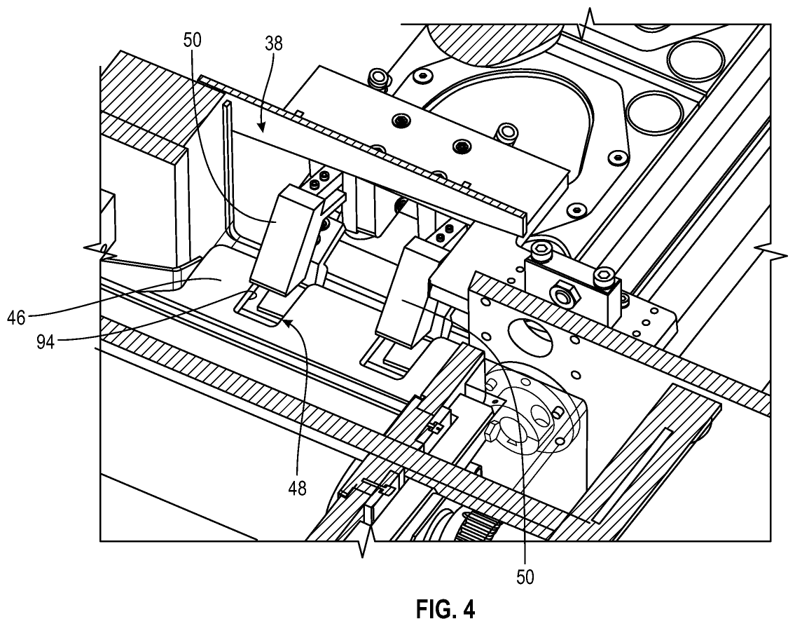

FIG. 4 depicts the step of the operation of the feed station 34 wherein the gripper 38 has moved across the carrier 30 and is in position to grab the free end of the roll 300 of material. In one aspect, the feed 36 includes a slitted opening 44. The slitted opening 44 is disposed on a generally horizontal plane. The slitted opening 44 may be formed by a pair of feed plates 46 which are spaced apart from each other so as to define the slitted opening 44. In another aspect of the feed 36, the feed 36 may include a pair of recesses 48 disposed along an outer edge of the feed 36 and defining a generally u-shaped opening. The recesses 48 have a width configured to receive the grippers 38. The tensioning element 42 and the feed 36 are configured to assist with the deployment of the material across the carrier 30.

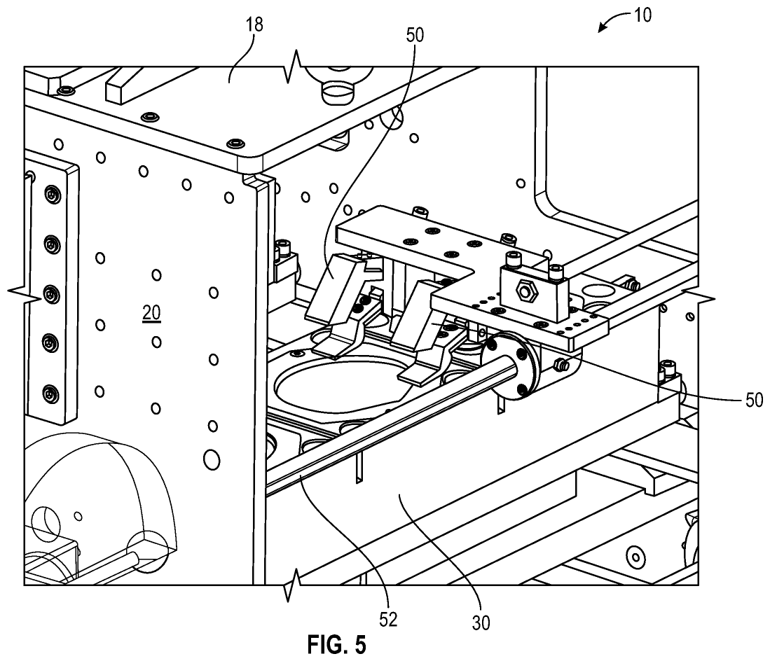

FIG. 5 illustrates a step in the operation of the feed station 34 showing the grippers 38. In another aspect, the gripper 38 includes a pair of opposable fingers 50. The opposable fingers 50 are configured to open and close. The gripper 38 is movable along a first axial guide 52. The first axial guide 52 traverses the axial length of the carrier 30. The gripper 38 is movable between near position and a far position.

FIG. 3 depicts the gripper 38 in the far position. FIG. 4 depicts the gripper 38 in the near position the gripper 38 is positioned to grab the free end of material from the roll 300. In particular, the fingers 50 remain open and are positioned within the pair of recesses 48. The fingers 50 are then closed onto the material, and the gripper 38 is moved to the far position so as to pull the material across the carrier 30.

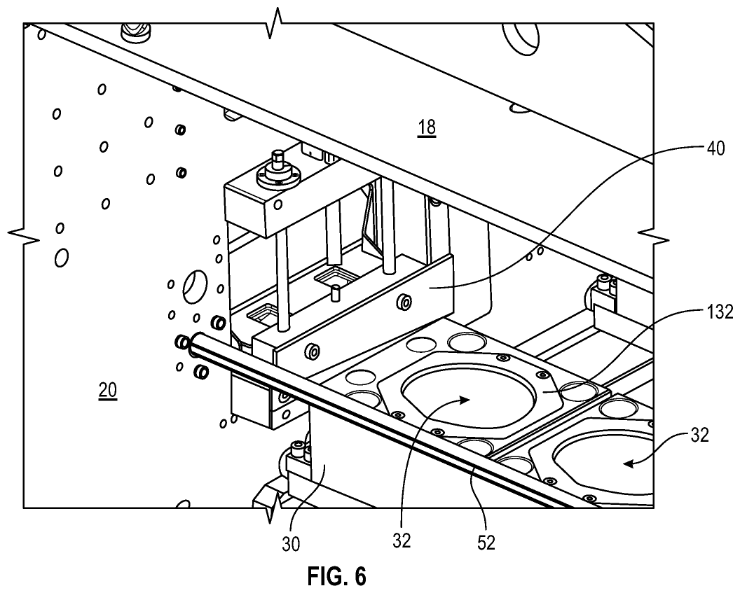

FIG. 6 depicts an illustrative example of the guillotine 40. Once the material is pulled across the carrier 30, the guillotine 40 is operable to cut the material so as to form a sheet of material. The guillotine 40 is a blade that may be moved from an up position to a down position. The guillotine 40 makes the cut after the gripper 38 has completed a cycle of travel, that is moved from the far position to the near position and back to the far position. Once the cut is made, the guillotine 40 returns to the up position to allow for the pull of new material from the roll 300. Once the feed station 34 completes the cycle of operation, the carrier 30 may advance through the operation of the machine 10 with the sheet of material disposed thereon.

With reference now to FIGS. 7-9, the machine 10 further includes a shell forming station 54. The shell forming station 54 is configured to form the shape of the mask 200. The shell forming station 54 is mounted to the gantry 18. The shell forming station 54 includes a shell support 56 movable between a press position and a disengaged position. The shell support 56 may be driven by a pneumatic drive 58. The shell support 56 is preferably formed of a rigid and durable material such as stainless steel. The shell support 56 includes a plurality of molding core inserts 60 corresponding in number to the molding cavity inserts 32. The shell forming station 54 is configured to press the molding core inserts 60 into the molding cavity inserts 32 so as to press the material therebetween and form a shape of the mask 200.

With reference again to FIG. 9, the machine 10 further includes a welding station 62. The welding station 62 is configured to weld the material together. The welding station 62 is mounted to the gantry 18. The welding station 62 includes a welding base 64 movable from a welding position to a disengaged position. The welding base 64 may be driven by a pneumatic drive 58. The welding base 64 includes a plurality of welding horns 66 disposed on the welding base 64. The number of welding horns 66 are equal to the number of molding cavity inserts 32. The welding horns 66 include a sonicator. The sonicator is configured to vibrate the welding horn 66 so as to generate a predetermined ultrasonic vibration at a predetermined frequency and a predetermined amplitude so as to weld the sheet of material. The frequency and amplitude may be tuned by the shape of the welding horn 66. It should be appreciated that the ultrasonic vibration may be changed based upon the material used to form the mask 200. Accordingly, in one aspect, the welding horns 66 are removably attached to the pneumatic drive 58 so as to allow the machine 10 to manufacture masks 200 of various material.

With reference again to FIG. 9, the machine 10 further includes a cutting station 68. The cutting station 68 is configured to cut the mask 200 from the sheet of material. The cutting station 68 includes a cutting base 70. The cutting base 70 is slidably mounted to gantry 18 and driven by a pneumatic drive 58. The cutting base 70 includes a plurality of cutting dies 72 disposed on a bottom surface of the cutting base 70. The cutting base 70 is movable from a cutting position to a disengaged position. In the cutting position, the cutting dies 72 are pressed against the sheet of material so as to cut out a peripheral of the mask 200 from the sheet of material so as to separate the formed mask 200 from the sheet of material. The cutting base 70 is then moved to the disengaged position so as to allow the carrier 30 to advance.

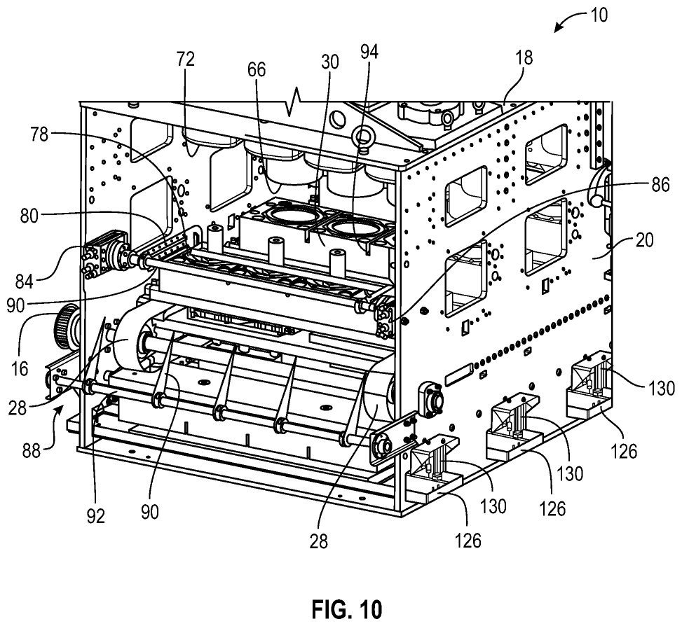

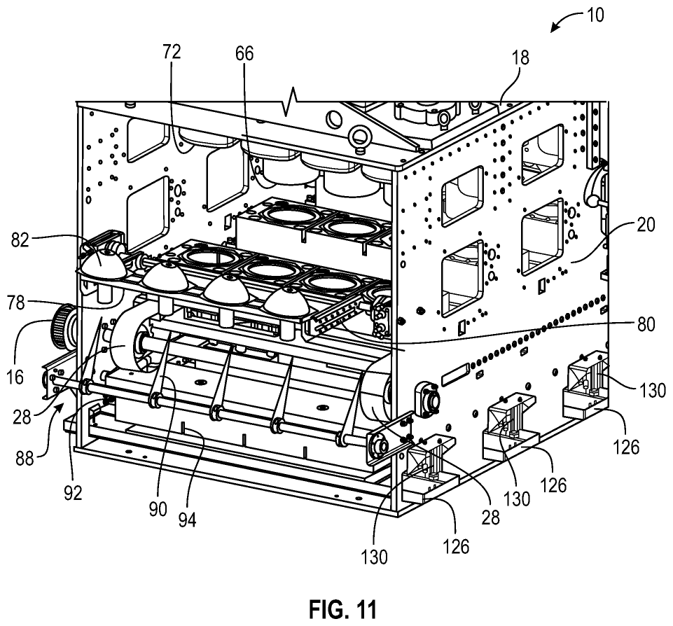

With reference now to FIGS. 10 and 11, the machine 10 further includes a mask grabbing apparatus 74. The mask grabbing apparatus 74 is configured to grab the masks 200 from the molding cavity inserts 32 and place the masks 200 in a position for retrieval. The mask grabbing apparatus 74 is rotatable about an axis, defined by an axial rod 76, between a first position and a second position.

The mask grabbing apparatus 74 includes a grabbing base 78 fixedly attached to the axial rod 76 by a pair of grabbing arms 80. In one aspect, the grabbing arms 80 are disposed on opposite sides of the grabbing base 78. The grabbing base 78 includes a plurality of mask gripping cores 82. The mask gripping cores 82 are generally shaped to conform to the inner surface of the mask 200. A first rotating drive 84, such as a servo motor, is operable to rotate the grabbing arms 80 from the first position to the second position.

FIG. 11 shows the mask grabbing apparatus 74 in the second position wherein the mask gripping cores 82 are seated with the molding cavity inserts 32. A pneumatic intake 86 is coupled to each of the mask gripping cores 82. The pneumatic intake 86 sucking the mask 200 within each of the plurality of molding cavity inserts 32 so as to retain the masks 200 to the mask gripping cores 82. The mask grabbing apparatus 74 is then movable to the first position wherein the mask 200 on each of the mask gripping cores 82 may be retrieved, as shown in FIG. 10. In the first position, the pneumatic intake 86 is turned off so as to allow for the retrieval of the mask 200. For illustrative purposes, the first position is shown as a position where the masks 200 are laid upright; however, it should be appreciated that the position of the masks 200 may change relative to what is shown in the drawings. As an example, the grabbing arms 80 may be rotated further so as to dump the masks 200 onto a tray (not shown). In another aspect, the grabbing apparatus may include a second rotating drive (not shown) configured to rotate the grabbing base 78 so as to dump the masks 200 into a tray.

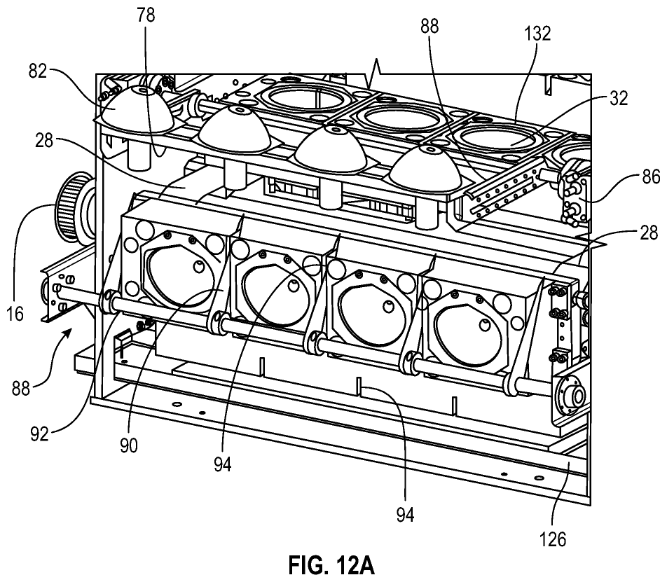

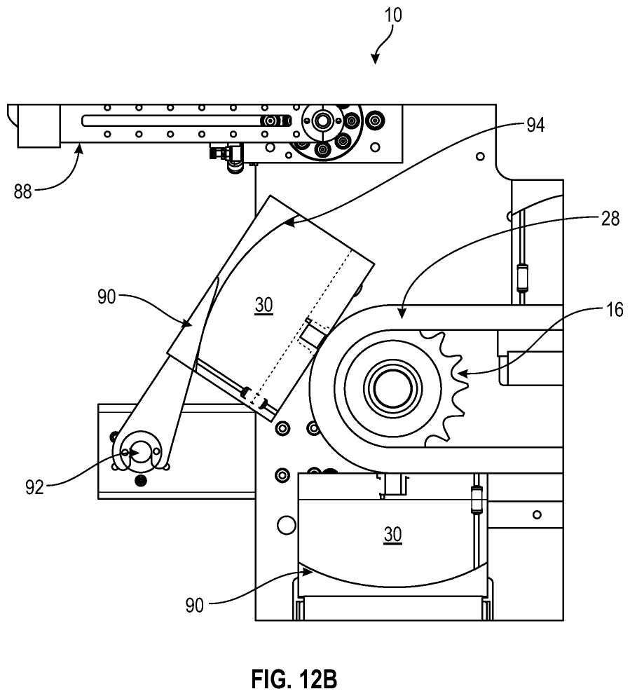

With reference again to FIGS. 10 and 11 and now to FIGS. 12A and 12B, the machine 10 may further includes a rake assembly 88. The rake assembly 88 is illustratively shown as being fixed to the frame 14. In particular, the rake assembly 88 is fixed to a back of the frame 14 and traverses the open back. The rake assembly 88 includes a rake rod 92 fixed on each end to opposing side plates 20 of the frame 14. The rake assembly 88 includes a plurality of rakes 90 spaced apart from each other. The rakes 90 are spaced apart from the distal end of the conveyor 16 so as to engage a top surface of the carriers 30 as the carriers 30 are advanced past the cutting station 68. The rakes 90 are configured to engage a top surface of the carrier 30 so as to remove a remaining portion of the sheet of material from the carriers 30.

In one aspect, the rakes 90 are fixedly mounted to the rake rod 92. The rakes 90 are dimensioned the same as each other and are illustratively shown as being planar ramp shaped members. It should be appreciated that the rakes 90 may be biased so as to return to a working position as shown in FIGS. 10, 11, 12A and 12B. For instance, the rakes 90 or the rake rod 92 may include a biasing member (not shown) configured to urge the rakes 90 to the normal position, wherein an engagement with the carrier 30 deflects the rakes 90 in a counter-clockwise position as the carrier 30 rounds the distal end of the conveyor 16.

With reference again to FIG. 12A, in one aspect of the machine 10, each of the carriers 30 include a plurality of slits 94 spaced apart from each other. The slits 94 are disposed on the top surface of the plurality of carriers 30. The slits 94 are configured to receive the rakes 90. In one aspect, each of the slits 94 has an arcuate bottom surface which is radial to a travel of a corresponding one of the carriers 30 about a turn in the conveyor 16, as shown in FIG. 12B. In particular, since the carriers 30 are fixed to the belt 28, the end of the conveyor 16 belts 28 are rounded and the slits 94 are radial to the travel of the carriers 30 about the rounded end of the conveyor 16.

With reference again to FIGS. 7-9, the in one aspect of the machine 10, the carriers 30 include at least one indent 96 and the shell support 56 includes at least one draw pin. The draw pin 98 may include a biasing member 98 disposed internally so as to allow the draw pin 98 to be compacted. The draw pin 98 and the indent 96 cooperate to fix the sheet of material onto the carrier 30. The draw pin 98 is slidably mounted to the shell support 56. The biasing member is configured to continuously urge a head 100 of the draw pin 98 downwardly with respect to the shell support 56 so as to extend beyond a distal end of the molding core inserts 60. The conveyor 16 is configured to position the draw pins 98 so as a corresponding indent 96.

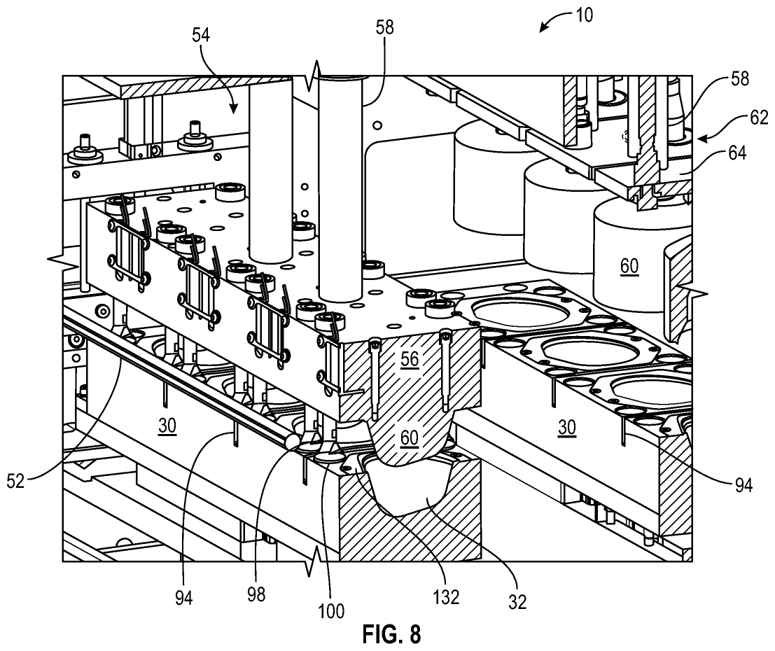

FIG. 7 depicts the draw pins 98 in an extended position, wherein the draw pins 98 are registered to a corresponding indent 96. For illustrative purposes, the machine 10 is shown as having four (4) draw pins 98 and four (4) indent 96s at each corner of a molding cavity. FIG. 8 depicts the molding core pressed downwardly relative to FIG. 7, and shows the head of each draw pin 98 seated within a respective indent 96. Thus, the draw pin 98 presses the sheet of material into the indent 96, generating a tension along the sheet of material which eliminates any wrinkles. FIG. 9 shows the molding core inserts 60 and the molding cavity inserts 32 closed together. The draw pins 98 are compacted and the head 100 is flush against the shell support 56.

With reference again to FIGS. 7-9, in another aspect of the machine 10, the machine 10 includes a collar 102. The collar 102 is configured to establish a stroke length of the draw pin 98. In one aspect, the collar 102 is removably engage to a shaft of the draw pin 98. The collar 102 is mounted to the shaft of the draw pin 98 so as to establish a stroke length of the at least one draw pin 98. The figures show that the collar 102 is mounted to a distal end of the shaft of the draw pin 98. However, it should be appreciated that the collar 102 may be mounted to a position of the shaft closer to the head 100 of the draw pin 98, thereby reducing the stroke length of the draw pin 98. For example, the draw pin 98 may be seated within the shell support 56 in such a manner that the head 100 of the draw pin 98 is flush against the working surface of the shell support 56 and the collar 102 is seated against the top surface of the shell support 56 and clamped around the shaft of the draw pin 98 wherein a length of the shaft extends beyond the collar 102. It should be appreciated that changing the position of the collar 102 on the shaft will adjust the stroke length of the draw pin 98. It should be appreciated that the term “stroke length” refers to the length that the head of the draw pin 98 retracts when the shell support 56 is closed onto the carrier 30. Thus, is instances where the head of the draw pin 98 is seated within the shell support 56, there is no stroke length.

In another aspect of the machine 10, the molding core inserts 60, molding cavity inserts 32 and cutting die 72 are removable attached to the respective carriers 30, the shell support 56 and the cutting base 70. Thus, the machine 10 may be configured to manufacture masks 200 of different shapes and sizes. The molding core inserts 60, molding cavity inserts 32 and cutting dies 72 being configured to assume the shape of the desired mask 200.

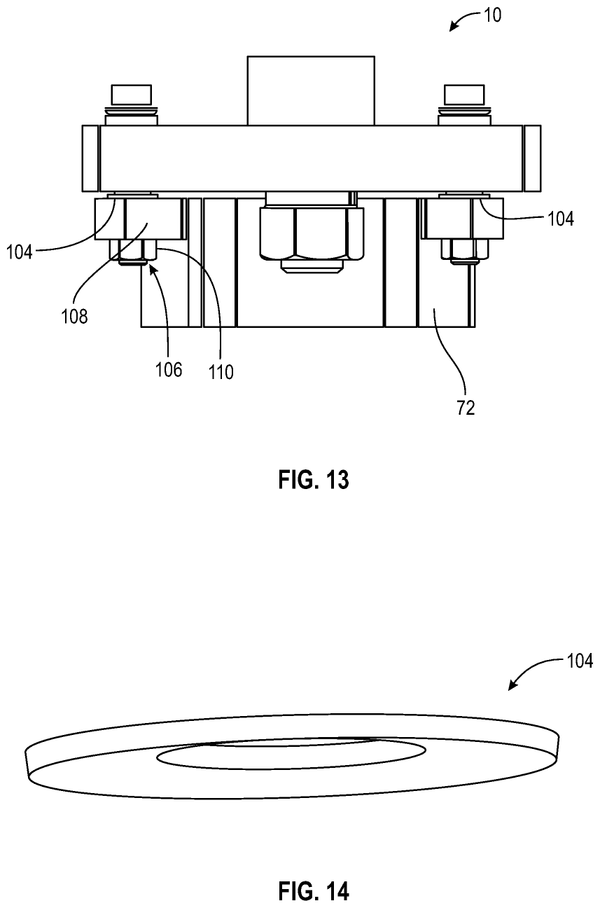

With reference now to FIGS. 13 and 14, in another aspect of the machine 10, the cutting station 68 includes a dampening member 104 disposed between the cutting base 70 and the plurality of cutting dies 72. The dampening member 104 may help preserve the cutting edge of the cutting dies 72. FIG. 13 is an isolated view of the cutting die 72. The cutting die 72 is removable coupled to the cutting base 70 via a mechanical fastener 106.

In this aspect, the mechanical fastener 106 is a nut 108 and a threaded screw 110 that is threaded to a threaded bore of the cutting base 70. The dampening member 104 is disposed between the nut 108 and the cutting base 70. The dampening member 104 is configured to be compressed and return to a natural state wherein a height of the dampening member 104 is greater than the height of the dampening member 104 in the compressed state.

FIG. 13 shows the dampening member 104 in a natural state. The nut 108 is fixed to the outer surface of the cutting die 72. FIG. 13 shows that in the natural state, the dampening member 104 spaces the cutting die 72 apart from the cutting base 70 so as to form a gap. When the cutting die 72 is pressed against the carrier 30, the gap is closed. Any dampening member 104 currently known or used may be adapted or modified for use herein, illustratively including the dampening member 104 shown in FIG. 14.

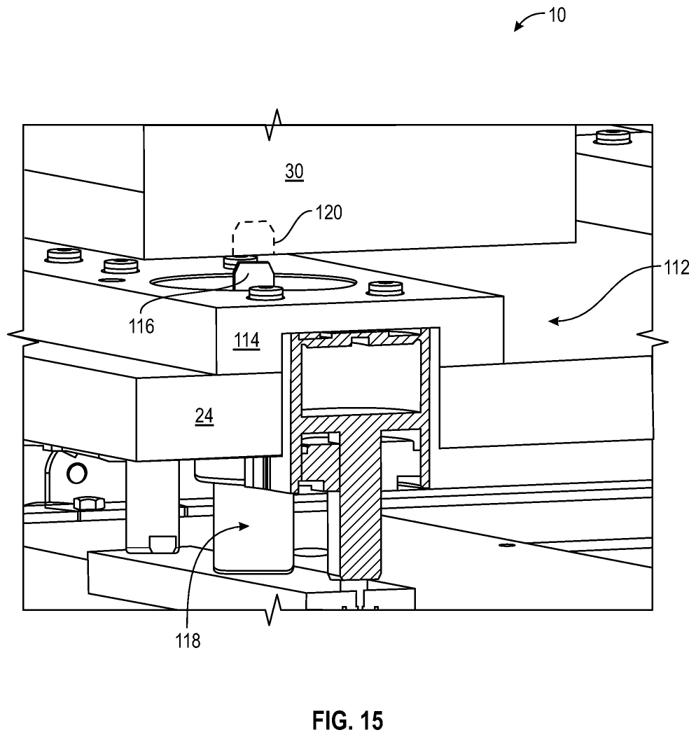

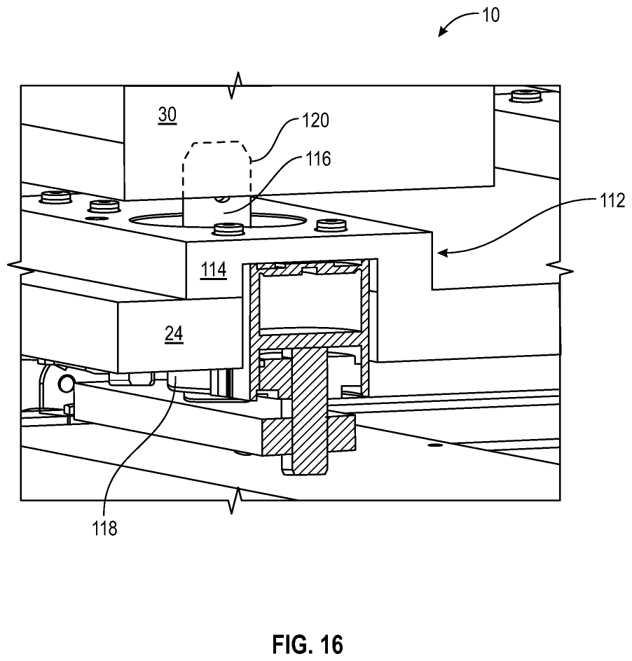

With reference now to FIGS. 15 and 16, in another aspect, the machine 10 further includes a registration assembly 112 fixed to the support plate 24. The registration assembly 112 is configured to position the carriers 30 with respect to each of the shell forming station 54, welding station 62 and cutting station 68. The registration assembly 112 includes a registration plate 114. The registration plate 114 is fixed to the support plate 24. The registration assembly 112 includes a registration pin 116 movable from an engaged position and a disengaged position. A registration drive 118 is configured to move the registration pin 116 from the engaged position and the disengaged position. The registration drive 118 may be a servo motor.

Each of the carriers 30 includes a registration slot 120. In particular, the registration slot 120 is disposed on the bottom surface of the carrier 30. The registration pin 116 is configured to be inserted into the registration slot 120 when the registration pin 116 is moved to the engaged position so as to position the carriers 30 with respect to the frame 14. FIG. 15 shows the registration pin 116 in the disengaged position. The distal end of the registration pin 116 is spaced apart from the bottom surface of the carrier 30. FIG. 16 shows the registration pin 116 in the engaged position, wherein the registration pin 116 is advanced upwardly with respect to FIG. 15. The registration pin 116 is seated within the registration slot 120 of the carrier 30 thus placing the carrier 30 is a predetermined position.

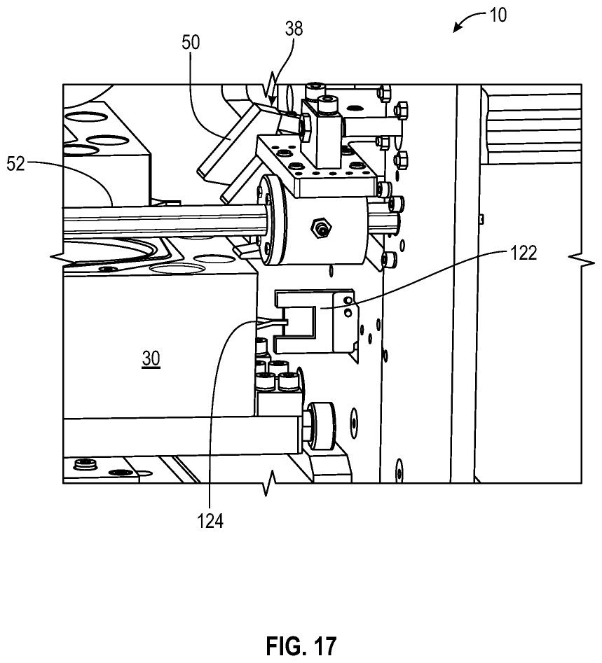

With reference now to FIG. 17, the machine 10 may further include a position sensor 122. The position sensor 122 is configured to detect a position of the carriers 30 and transmit the position to the controller 12. The position sensor 122 may be a laser configured to detect a position of the carrier 30. As shown in FIG. 17, the carrier 30 may include a positioning member 124. For illustrative purposes, the positioning member 124 is disposed on a sidewall and projects outwardly from the side wall. FIG. 17 shows the positioning member 124 breaking the laser, indicating that the carrier 30 is in the proper position. The controller 12 is configured to stop the conveyor 16 when the position sensor 122 detects the carriers 30 are in a proper position. The controller 12 may be further configured to actuate the registration assembly 112 so as to move the registration pin 116 into the engaged position after the controller 12 has stopped the conveyor 16.

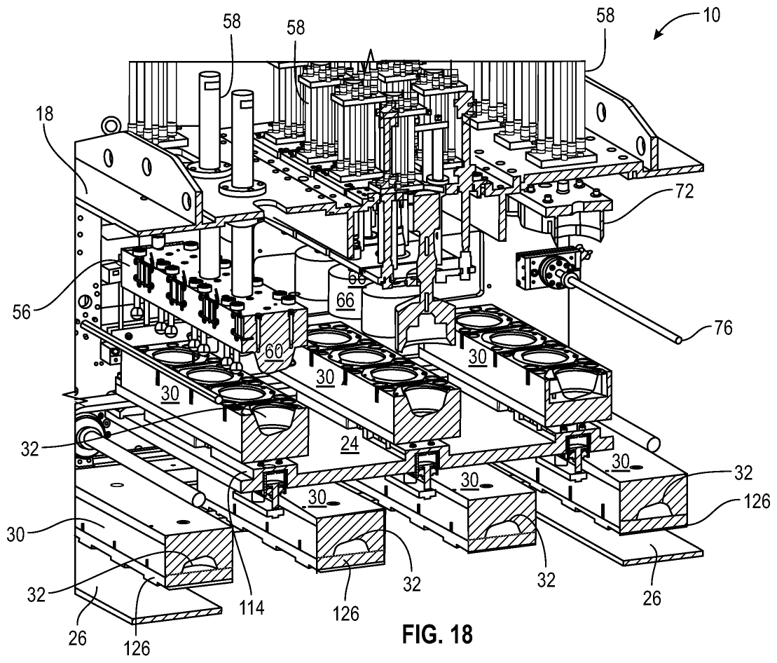

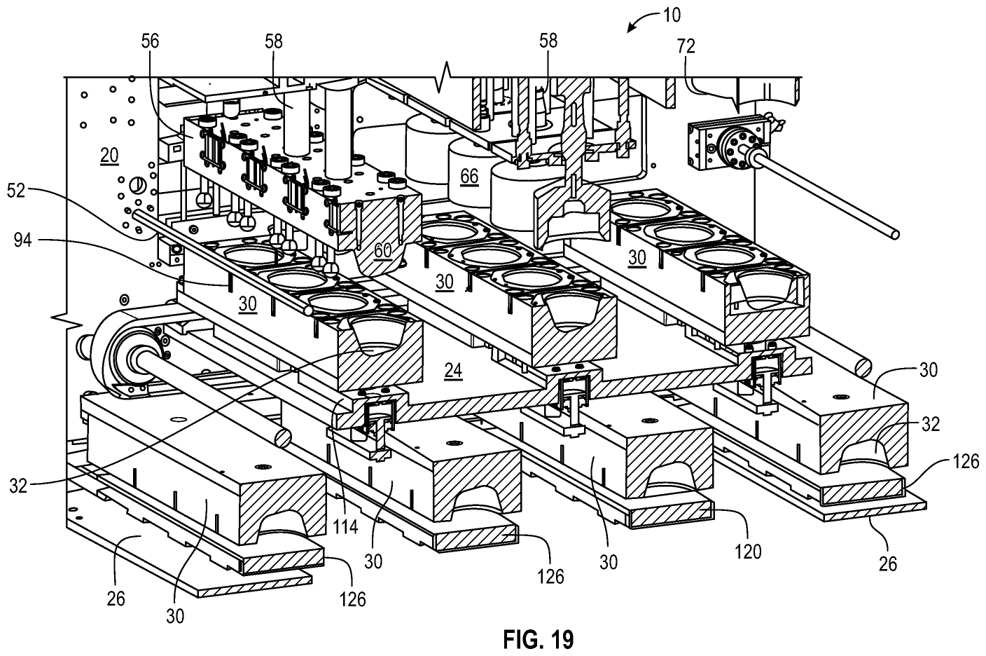

With reference now to FIGS. 18 and 19, the machine 10 may further include a heating plate 126. In one aspect, each heating plate 126 includes a heating element for generating heat. In another aspect, the heating plates 126 are thermally coupled to a heat source. For illustrative purposes, the machine 10 is shown as having four (4) heating plates 126. The frame 14 includes four plate openings 128 on each of the side plates 20 and the four plate openings 128 are diametrically opposed to each other. The heating plates 126 extend through opposing plate openings 128 of the side plates 20 of the frame 14. The heating plates 126 are disposed beneath the support plate 24 and are spaced apart from the support plate 24 so as to accommodate the travel of the carriers 30 along the bottom portion of the belt 28.

The heating plate 126 is movable between an engaged position and a disengaged position. A heating plate 126 drive 130 is configured to move the heating plate 126 between the engage position and the disengaged position. FIG. 18 shows the heating plates 126 in the engaged position, wherein the heating plates 126 are thermally coupled to the carriers 30 disposed on the bottom of the belt 28. In particular, as the carriers 30 are on the bottom of the belt 28, the heating plates 126 are pressed against a top surface of the carriers 30. FIG. 19 shows the heating plates 126 in the disengaged position wherein the heating plates 126 are spaced apart from the top surface of the carriers 30.

With reference again to FIGS. 6 and 9, the carriers 30 may further include an anvil 132. The anvil 132 is formed of a generally rigid and durable material. The anvil 132 is a plate shaped member having an opening stamped out of the plate shaped member. The opening generally defines the outer peripheral edge of the mask 200. The anvil 132 has a width bounding the opening which is configured to dampen a load applied by the shell forming station 54, welding station 62 and cutting station 68.

FIG. 6 provides an isolated view of the anvil 132. FIG. 9 shows the shell forming station 54, welding station 62 and cutting station 68 formed a closed mold with respect to the carriers 30. Each of the respective, molding core inserts 60, welding horn 66 and cutting dies 72 are pressed against the anvil 132, with over time may cause wear. In a preferred aspect, the anvil 132s are removably attached to the carrier 30 so as to allow the manufacturer to replace the anvil 132s and maintain the precision manufacture of the mask 200.

With reference again to the figures a description of the operation of the machine 10 is provided. The operation of the machine 10 will be described in a cycle wherein a cycle is the number of operational steps required to manufacture a mask 200. For clarity, the operation will be described from a cold start, wherein the roll 300 of material has yet to be placed over the carrier 30. A description of the operation will be made with reference to a first carrier 30 so as to illustrate the different manufacturing steps.

With reference first to FIGS. 1 and 3, the gripper 38 is shown in the far position. controller 12 is actuates the gripper 38 to move from the far position to the near position, shown in FIG. 4. In the near position, the fingers 50 of the grippers 38 are seated within the pair of recesses 48 of the feed 36. The controller 12 then actuates the gripper 38 so as to close the fingers 50 onto the free end of the roll 300 of material disposed within the pair of recesses 48. The controller 12 then actuates the gripper 38 so as to move the gripper 38 to the far position, pulling the sheet of material across the first carrier 30. The guillotine 40 is in the up position, and the controller 12 actuates the guillotine 40 to move the guillotine 40 into the down position and cut the roll 300 of material so as to form a sheet of material. The controller 12 then actuates the guillotine 40 so as to return the guillotine 40 to the up position.

With reference now to FIG. 7, the shell support 56 is in the disengaged position during the operation of the feed station 34. Once the guillotine 40 returns to the up position, the controller 12 actuates the shell support 56 so as to move the shell support 56 to the press position. FIG. 8 shows the shell support 56 advanced downwardly relative to FIG. 7, wherein the heads of the draw pins 98 are seated within a corresponding indent 96 of the first carrier 30 and places a surface tension onto the sheet of material so as to eliminate wrinkles. FIG. 9 depicts the shell support 56 in the press position, forming a closed mold, wherein the shape of the mask 200 is formed. As the shell support 56 moves to the press position, the draw pins 98 are biased inwardly into the shell support 56.

The controller 12 then actuates the shell support 56 so as to move the shell support 56 from the press position to the disengaged position, as shown in FIG. 7. The controller 12 than actuates the conveyor 16, advancing the first carrier 30 with the formed mask 200 to the welding station 62. In a preferred aspect, the controller 12 receives a signal from the position sensor 122, shown in FIG. 17, indicating that the carriers 30 are in a proper position and the controller 12 stops the movement of the conveyor 16. Once the conveyor 16 is stopped, the controller 12 actuates the registration assembly 112 so as to position the registration pin 116 into an engaged position with respect to the registration slot 120 of the corresponding carrier 30. It should be appreciated that the machine 10 may include a registration plate 114 underneath each of the respective work stations (as used herein, the term “work station” refers to the feed station 34, shell forming station 54, welding station 62 and cutting station 68 collectively), and thus each carrier 30 is precisely placed underneath a corresponding work station.

Once the registration pin 116 is moved to an engaged position, the controller 12 actuates the welding base 64 from the disengaged position to the welding position, as shown in FIG. 9. Once in the welding position, the welding horns 66 are pressed against the first carrier 30. The controller 12 actuates the welding horns 66 so as to generate the predetermined ultrasonic vibration. The welding horn 66 is actuated for a predetermined period, after which the controller 12 moves the welding base 64 to the disengaged position.

Once in the disengaged position, the controller 12 then actuates the conveyor 16 so as to advance the first carrier 30 to the cutting station 68. Again, the controller 12 advances the conveyor 16 until a signal from the position sensor 122 indicates that the carriers 30 are in a proper position. Again, once in the proper position, the controller 12 actuates the registration assembly 112 so as to precisely position the carriers 30.

Once the registration pin 116 is moved to an engaged position, the controller 12 actuates the cutting base 70 from the disengaged position to the cutting position, as shown in FIG. 9. Once in the cutting position, the cutting die 72 are pressed against the first carrier 30, cutting out the mask 200 from the sheet of material. The controller 12 then actuates the cutting base 70 to return to the disengaged position.

Once the cutting base 70 is in the disengaged position, the controller 12 actuates the mask grabbing apparatus 74 wherein the grabbing base 78 is moved from the first position as shown in FIG. 11 to the second position as shown in FIG. 10. In the second position, the mask gripping cores 82 are seated within a respective molding cavity of the carriers 30 which now hold a mask 200. The controller 12 then actuates the pneumatic intake 86 sucking each of the formed masks 200 to a respective mask 200 gripping core. The controller 12 then actuates the grabbing apparatus so as to return the grabbing base 78 to the first position, and turns of the pneumatic intake 86 when the grabbing base 78 is returned to the first position, wherein the masks 200 may be retrieved.

Once, the grabbing base 78 is returned to the first position, the controller 12 advances the conveyor 16 and the first carrier 30 travels along the rounded end of the back conveyor 16. The rakes 90 are positioned so as to engage a respective slit 94 of the first carrier 30. As such, the rakes 90 are placed underneath the sheet of material remaining on the first carrier 30 and lift the remaining sheet of material from the first carrier 30.

The controller 12 actuates the conveyor 16 until the position sensor 122 indicates that the carriers 30 are in position, wherein the conveyor 16 is stopped so as to place the first carrier 30 underneath the support plate 24. The controller 12 is then configured to actuate the heating plate 126 so as to move the heating plate 126 from a disengaged position to the engaged position, wherein in the engaged position the heating plate 126 is pressed against the top surface of the first carrier 30.

The operation of the machine 10 continues in such a manner as described, wherein four masks 200 are produced after each cycle of operation. Naturally, the first carrier 30 continues to be advanced in the manner described above and will return to the feed station 34 wherein the first carrier 30 is provided with a sheet of material for mask 200 making operations.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A machine configured to manufacture a mask formed of at least one material supplied by a roll of the at least one material, the machine comprising:
a controller;
a frame having a gantry and a support plate disposed beneath the gantry, the support plate fixed to the frame;
a conveyor operable to rotate belt;
a plurality of carriers fixedly mounted to the belt so as to be carried around the support plate, wherein the plurality of carriers include a plurality of molding cavity inserts;
a feed station for supplying the at least from material from the roll to the conveyor, the feed station having a gripper configured to pull the at least one material across one of the plurality of carriers and a guillotine configured to cut the at least one material so as to form a sheet of material on a respective one of the plurality of carriers;
a shell forming station mounted to the gantry, the shell forming station having a shell support and a plurality of molding core inserts disposed on the shell support, the shell forming station configured to press the plurality of molding core inserts into the plurality of molding cavity inserts pressing the at least one material therebetween so as to form a shape of the mask;
a welding station, the welding station including a welding base and a plurality of welding horns disposed on the welding base, the plurality of welding horns configured to generate a predetermined ultrasonic vibration at a predetermined frequency and a predetermined amplitude so as to weld the sheet of material;
a cutting station having a cutting base and a plurality of cutting dies disposed on the cutting base, the plurality of cutting dies configured to cut out a peripheral of the mask from the sheet of material so as to separate the mask from the sheet of material; and
a mask grabbing apparatus rotatable about an axis between a first position and a second position, the mask grabbing apparatus including a plurality of mask gripping cores, wherein in the second position the plurality of mask gripping cores are seated with the plurality of molding cavity inserts;
a pneumatic intake coupled to each of the plurality of mask gripping cores, the pneumatic intake sucking the mask within each of the plurality of molding cavity inserts so as to retain the mask to the respective one of the plurality of mask gripping cores, the mask grabbing apparatus movable to the first position wherein the mask on each of the mask gripping cores may be retrieved.

2. The machine as set forth in claim 1, further including a rake assembly having a plurality of rakes spaced apart from each other, the rake assembly spaced apart from the conveyor so as to engage a top surface of the plurality of carriers and remove a remaining portion of the sheet of material from the respective one of the plurality of carriers.

3. The machine as set forth in claim 2, the each of the plurality of carriers include a plurality of slits spaced apart from each other and disposed on the top surface of the plurality of carriers, the plurality of slits configured to receive the plurality of rakes.

4. The machine as set forth in claim 3, wherein each of the plurality of slits has an arcuate bottom surface which is radial to a travel of a corresponding one of the plurality of carriers about a turn in the conveyor.

5. The machine as set forth in claim 1, wherein the gripper includes a pair of opposable fingers configured to open and close, the gripper movable along a first axial guide, the axial guide traversing the respective one of the plurality of carriers, the gripper movable between near position and a far position, wherein in the near position the gripper is moved toward the roll of at least one material and the fingers are closed onto the at least one material, the gripper moved to the far position so as to pull the at least one material across the respective one of the plurality of carriers.

6. The machine as set forth in claim 1, wherein the plurality of carriers include at least one indent; and
the shell forming unit includes at least one draw pin and a biasing member, the draw pin slidably mounted to the shell base and the biasing member configured to urge a head of the draw pin downwardly with respect to the shell base so as to extend beyond a distal end of the plurality of molding core inserts, the at least one draw pin being positioned so as to engage the at least one indent.

7. The machine as set forth in claim 6, further including a collar removably engage a shaft of the at least one draw pin, the collar mounted to the shaft of the at least one draw pin so as to establish a stroke length of the at least one draw pin.

8. The machine as set forth in claim 1, the plurality of molding core inserts, cavity inserts and cutting die are removable attached to the plurality of carriers, the shell base and the cutting base.

9. The machine as set forth in claim 1, wherein the cutting station includes a dampening member disposed between the cutting base and the plurality of cutting dies.

10. The machine as set forth in claim 1, further including a registration assembly fixed to the support plate, the registration assembly including a registration plate having a registration pin movable from an engage position and a disengage position; and
each of the plurality of plurality of carriers having a registration slot; wherein the registration pin is configured to be inserted into the registration slot when the registration pin is moved to the engaged position so as to position the plurality of carriers with respect to the frame.

11. The machine as set forth in claim 10, further including a position sensor, the position sensor configured to detect a position of the plurality of carriers and transmit the position to the controller, the controller stopping the conveyor when the position sensor detects the plurality of carriers are in a proper position.

12. The machine as set forth in claim 11, wherein the controller is further configured to actuate the registration assembly so as to move the registration pin into the engaged position after the controller has stopped the conveyor.

13. The machine as set forth in claim 1, further including a heating plate, the heating plate disposed beneath the support plate, wherein the heating plate is movable between an engaged position and a disengaged position, wherein in the engaged position the heating plate is thermally coupled to a respective one of the plurality of carriers.

14. The machine as set forth in claim 1, further including an anvil, the anvil having an opening for receiving a respective on of the plurality of molding cores.
